(19) United States
(12) Patent Application Publication
(10) Pub. No.: US 2025/0137200 A1
(43) Pub. Date: May 1, 2025

(54) HIGH MOLECULAR WEIGHT GPAM WITH ANIONIC POLYMERIC PROMOTER

(71) Applicant: KEMIRA OYJ, Helsinki (FI)

(72) Inventors: Chen LU, Marietta, GA (US); Junhua CHEN, Mableton, GA (US); Harold GOLDSBERRY, Blacksburg, VA (US)

(21) Appl. No.: 18/837,906

(22) PCT Filed: Feb. 10, 2023
(86) PCT No.: PCT/US2023/062347

§ 371 Date: Aug. 13, 2024

Related U.S. Application Data
(60) Provisional application No. 63/309,850, filed on Feb. 14, 2022.

(30) Foreign Application Priority Data
Apr. 7, 2022 (FI) 20225306

(51) Int. Cl. D21H 17/37; D21H 17/00; D21H 21/18

(52) U.S. Cl. CPC D21H 17/37; D21H 17/72; D21H 21/18

(57) ABSTRACT

Compositions and processes for strengthening paper products are provided. The inventive compositions comprise a combination at least one cationic glyoxalated polyacrylamide (“GPAM”) comprising a high molecular weight base polymer and at least one anionic polymeric promoter (“APP”). The inventive process for manufacturing paper products with enhanced strength and improved wet decay properties comprises adding to a fiber stock comprising cellulosic fibers at least one cationic glyoxalated polyacrylamide (“GPAM”) comprising a high molecular weight base polymer; and at least one anionic polymeric promoter (“APP”).

### RELATED APPLICATIONS

This application claims priority to U.S. Provisional Application No. 63/309,850, filed on Feb. 14, 2022, and to Finnish Application Number 20225306, filed on Apr. 7, 2022, the contents of both of which applications are incorporated by reference in their entireties.

### FIELD OF THE INVENTION

The present invention generally relates to a combination of at least one cationic glyoxalated polyacrylamide (“GPAM”) comprising a high molecular weight base polymer and at least one anionic polymeric promoter (“APP”) for enhancing the wet and/or dry strength of paper and board, and methods of use thereof. More specifically, the invention relates to adding to a cellulosic fiber stock, e.g., a thick stock, further optionally one comprising any of the following: softwood fibers, hardwood fibers, recycled fibers, refined fibers, mill broke fibers, non-wood fibers, including but not limited to straw and wheat pulp, or a mixture of any of the foregoing, or a pulp selected from Kraft pulp, bleached pulp, unbleached pulp, process water from pulp, paper, and/or board production, neutral sulfite semi chemical (NSSC) pulp, mechanical pulp, or a mixture of any of the foregoing:
(i) a cationic glyoxalated polyacrylamide (“GPAM”) comprising a high molecular weight base polymer and
(ii) an anionic polymeric promoter (“APP”);
thereby forming a strengthened paper product with improved tensile strength and/or improved wet decay.

### BACKGROUND OF THE INVENTION

In papermaking applications, a strengthening agent is often employed to provide desirable characteristics sought in the ultimate paper product. These characteristics include tensile strength of the dry and wet paper. Tensile strength is a measure of the resistance of a manufactured paper or paperboard product to breaking or tearing under a force load.

Glyoxylated polyacrylamide (GPAM) products are widely used in the paper industry, often to increase paper wet and dry strength. GPAM is generally prepared through the reaction between glyoxal and a cationic polyacrylamide base polymer which generally contains acrylamide monomers and a cationic monomer, such as DADMAC (for example, as discussed in U.S. Pat. Nos. 3,556,932, 4,605,702, and 7,828,934). The original GPAM was reported in U.S. Pat. No. 3,556,932. The cationic polyacrylamide base polymer has a molecular weight below 25,000 Da and a molar ratio of acrylamide to diallyldimethylammonium chloride of 99:1 to 75:1. U.S. Pat. No. 9,328,462 and No. 9506195 claim the combination of GPAM and an anionic polyacrylamide (APAM) to increase papermaking dewatering rate and also enhance paper strength properties.

GPAM is a common temporary wet strength resin. For example, glyoxylated polyacrylamide can increase the initial wet strength of many household tissues, a useful property as household tissues often come into contact with water during their use. Applying glyoxylated polyacrylamide to paper products can also increase the compression strength and the dimensional stability of many board-grade paper products.

GPAM is typically added in the pulp suspension before paper sheet formation. Upon drying of the treated paper sheet, GPAM is believed to form covalent bonds with paper cellulose to increase paper dry strength. Since the covalent bond between GPAM and cellulose is reversible in water, this wet strength may decrease rapidly over time. This rapid decrease in wet strength is desirable for flushed paper products, such as toiled paper, which disintegrate rapidly after use.

Because of these characteristics, GPAM has not been historically useful for enhancing permanent wet strength properties of absorbent paper products, such as paper towels, which must retain tensile strength after use.

For producing with enhanced prolonged wet strength, polyamidoamine epichlorohydrin (PAE) is the industrial standard chemical additive. PAE provides desirable wet strength characteristics and wet strength decay, however, the AOX generated during the manufacturing process of PAE is a potential environmental concern for the paper industry. Additionally, paper products comprising PAE are often difficult to recycle as the PAE renders repulping difficult. For these reasons, strengthening agents for enhancing wet strength without epichlorohydrin are highly desirable.

It is accordingly a purpose of this invention to provide a composition for enhancing wet strength of paper or board, which avoids the use of PAE.

It is an additional purpose of the present application to provide a papermaking process for manufacturing absorbent paper with enhanced wet strength and wet decay properties.

It is an additional purpose of the present application to provide a papermaking process for manufacturing absorbent paper with enhanced repulping dispersibility over paper strengthened with PAE.

The present application discloses a composition and method for employing high molecular weight cationic GPAM as a strengthening agent in combination with an anionic polymeric promoter (“APP”) for enhancing dry strength, initial wet strength, and permanent wet strength of paper products. The new system shows improved paper strength properties over the GPAM/APAM system with a GPAM base polymer molecular weight below 50 kDa. The inventive method satisfies a need for a cost effective and efficient strengthening agents for the papermaking industry which avoids the use of PAE and can be easily repulped.

### SUMMARY OF THE INVENTION

The present disclosure generally encompasses a composition or combination of materials for strengthening paper or board. This composition or combination may comprise at least one cationic glyoxalated polyacrylamide (“GPAM”) comprising a high molecular weight base polymer; and at least one anionic polymeric promoter (“APP”).

The present disclosure also generally encompasses a process for manufacturing one or more paper products with enhanced strength and improved wet decay properties. This process may comprise adding to a fiber stock comprising cellulosic fibers at least one cationic glyoxalated polyacrylamide (“GPAM”) comprising a high molecular weight base polymer; and at least one anionic polymeric promoter (“APP”).

In particular, the results disclosed herein demonstrate that the combination of high molecular weight cationic GPAM and APP can be used to enhance the strength parameters and repulping performance of one or more paper products, optionally absorbent paper products.

The subject process for preparation of one or more paper products afford one or more of the following advantages: (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa).

The present disclosure provides a composition for strengthening paper or board, optionally an aqueous composition. In some embodiments, the composition comprises at least one cationic glyoxalated polyacrylamide (“GPAM”) comprising a high molecular weight base polymer; and at least one anionic polymeric promoter (“APP”). In some embodiments, the high molecular weight base polymer has a weight average molecular weight selected from at least 50 kDa, at least 80 kDa, at least 100 kDa, at least 250 kDa, and 100-1000 kDa.

The present disclosure also provides a combination of materials. In some embodiments, the combination comprises at least one cationic glyoxalated polyacrylamide (“GPAM”) comprising a high molecular weight base polymer, optionally an aqueous composition; and at least one anionic polymeric promoter (“APP”).

In some embodiments, the high molecular weight base polymer (a) has a weight average molecular weight selected from at least 50 kDa, at least 80 kDa, at least 100 kDa, at least 250 kDa, and 100-1000 kDa. In some embodiments, the combination of materials (a) and (b), when both added separately, simultaneously, or as a pre-mixed combination to a papermaking system comprising a furnish composition or to a furnish composition, which furnish composition comprises cellulosic fibers used for the manufacture of paper or board, wherein (a) and (b) may be added in either order, and result in a paper or board material of enhanced strength compared to when said combination of materials (a) and (b), are not added to the papermaking system or to said furnish composition.

In some embodiments, the at least one cationic GPAM comprises one or more of the following:
a) comprises a glyoxal:base polymer weight ratio range selected from 1:99 to 50:50 and 5:95 to 20:80;
b) is obtained by reaction of glyoxal with said high molecular weight base polymer, wherein the high molecular weight base polymer comprises an acrylamide-based copolymer comprising neutral monomers, cationic monomers, and optionally anionic monomers, further wherein
   i) the neutral monomers are selected from the group of primary amide-containing monomers comprising acrylamide, methacrylamide, ethyl acrylamide, crotonamide, N-methyl acrylamide, N-butyl acrylamide, N-ethyl methacrylamide, and any combination thereof;
   ii) the cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) the optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent cationic monomer content ranging from 5-60% by weight, a percent anionic monomer content ranging from 0-50% by weight, and the remainder of the monomer content is nonionic;
d) has a cationic charge density range selected from the ranges comprising 0.4-5 meq/g, 1-4 meq/g, and 1.4-2 meq/g at pH 8.0;
e) is formulated in a manner selected from (i) as a dry powder and (ii) as an aqueous solution comprising a GPAM solids percent by weight range selected from 1-15%, 2-10%, and 4-8%; and
f) when added to a papermaking system or composition comprising cellulosic fibers used for the manufacture of paper or board, is added in a dosage selected from the ranges comprising 0.5-25, 3-12, 6-10 lb./ton of dry fibers.

In some embodiments, the at least one anionic polymeric promoter comprises one or more of the following:
a) has a weight average molecular weight selected from at least 10 kDa, at least 50 kDa, at least 100 kDa, at least 250 kDa, and 10-1000 kDa;
b) comprises a copolymer comprising neutral monomers, anionic monomers, and optionally cationic monomers, wherein
   i) said neutral monomers are selected from the group of vinyl monomers comprising acrylamide-based monomers, including but not limited to, acrylamide, methacrylamide, ethyl acrylamide, crotonamide, N-methyl acrylamide, N-butyl acrylamide, N-ethyl methacrylamide, and any combination thereof; acrylate-based monomers including esters thereof; N-vinylcarbamides; styrene; acrylonitrile; vinyl acetate; N-vinylpyrrolidone; N-vinyl-2-caprolactam; maleic anhydride; vinylethers; and any combinations thereof;
   ii) said cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) said optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent anionic monomer content ranging from 2-60% by weight, a percent cationic monomer content ranging from 0-50% by weight, and the remainder of the monomer content is nonionic;
d) has an anionic charge density range selected from the ranges comprising −10 to 4 meq/g, −8 to 2 meq/g, and −4 to −1 meq/g at pH 8.0;
e) is formulated in a manner selected from (i) formulated as a dry powder and (ii) formulated as an aqueous solution comprising an APP solids percent by weight range selected from 1-25%, 2-10%, and 4-8%; and/or
f) when added to a papermaking system or composition comprising cellulosic fibers used for the manufacture of paper or board, is added in a dosage selected from the ranges comprising 0.5-15, 1-8, and 2-5 lb./ton of dry fibers.

In certain embodiments, the composition or combination of (a) and (b) comprises one or more of the following:
a) when combined is/are formulated in a manner selected from (i) at least one dry powder (ii) at least one aqueous solution;
b) when combined has a ratio by weight of GPAM:APP (dry:dry) selected from the ranges comprising 1:20 to 20:1, 1:15 to 15:1, 1:10 to 10:1, 10:1 to 1:2, and 5:1 to 3:1; and/or
c) when combined has a net charge selected from the ranges comprising −5 to +5 meq/g, 0 to +5 meq/g, and +1 to +3.5.

In exemplary embodiments, the at least one cationic GPAM comprises a high molecular weight base polymer comprising a copolymer of (i) cationic monomers selected from DADMAC, AETAC, and combinations thereof; (ii) nonionic monomers selected from acrylamide, methacrylamide, and combinations thereof; and (iii) optionally anionic monomers selected from acrylic acid, its corresponding water soluble salts thereof, water dispersible alkali metal salts, alkaline earth metal salts, ammonium salts, and combinations thereof; and the at least one anionic polymeric promoter comprises a copolymer of acrylamide and acrylic acid, its corresponding water soluble salts thereof, water dispersible alkali metal salts, alkaline earth metal salts, ammonium salts, and combinations thereof.

In exemplary embodiments, the composition or combination when added to a papermaking system or composition comprising cellulosic fibers used for the manufacture of paper or board, results in a paper product comprising one or more of the following properties:
a) a percent of GPAM solids selected from the ranges comprising 0.02-10% by weight and 0.05-5% by weight of the dry paper product;
b) a percent of anionic polymeric promoter solids selected from the ranges comprising 0.02-10% by weight and 0.05-5% by weight of the dry paper product; and
c) (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa).

The invention also provides a furnish composition for the manufacture of paper or board, which has been treated with at least one strengthening system selected from the composition for strengthening paper or board and the combination of materials. In some embodiments, the furnish composition comprises an aqueous slurry of fiber stock comprising cellulosic fibers, and further comprises one or more of the following:
a) an aqueous slurry of cellulosic fibers optionally obtained from sources selected from softwood fiber, hardwood fiber, recycled fiber, refined fiber, mill broke fibers, non-wood fibers, including but not limited to straw and wheat pulp, and a mixture of any of the foregoing;
b) pulp selected from Kraft pulp, bleached pulp, unbleached pulp, process water from pulp, paper, and/or board production, neutral sulfite semi chemical (NSSC) pulp, mechanical pulp, and a mixture of any of the foregoing;
c) a stock selected from a thick stock, a thick stock diluted with chemical water, synthetic water, white water, and/or process water, and a thin stock, and a mixture of any of the foregoing;

In some embodiments, the amount of the at least one strengthening system, when added to a papermaking system comprising the furnish composition and/or to the furnish composition is sufficient to improve the strength properties of paper or board produced from said furnish composition compared to when said strengthening system is not added to the papermaking system comprising the furnish composition or to the furnish composition.

The present disclosure also generally encompasses a papermaking process for manufacturing one or more paper products, optionally one or more absorbent paper products, from a fiber stock comprising cellulosic fibers. In some embodiments, the process includes the addition of:
a) at least one cationic glyoxalated polyacrylamide (“GPAM”) comprising a high molecular weight base polymer, wherein said high molecular weight base polymer has a weight average molecular weight selected from at least 50 kDa, at least 80 kDa, at least 100 kDa, at least 250 kDa, and 100-1000 kDa; and
b) at least one anionic polymeric promoter (“APP”).

In some embodiments, (a) and (b) are both added separately or in combination during said papermaking process at one or more time points during papermaking selected from any time before, during, and after the paper product is formed; and/or (a) and (b) are both added separately or in combination at one or more locations in the paper making system; and/or (a) and (b) may be added as separate compositions in either order or are added as a pre-mixed composition comprising (a) and (b), optionally an aqueous composition, further optionally wherein if (a) and (b) are added separately the addition of (a) and (b) is simultaneous or proximate in time, e.g., (a) and (b) are added within one hour, 30 minutes, 10 minutes, 1 minute, or less than 1 minute of each other.

In some embodiments, the at least one cationic GPAM and the at least one anionic polymeric promoter:
a) are formulated as dry polymers or as aqueous solutions, each solution having a solids percent by weight range selected from the ranges comprising 1-25%, 1-15%, 2-10%, and 4-8%;
b) are added during said process to obtain a ratio by weight of GPAM:APP (dry:dry) selected from the ranges comprising 1:20 to 20:1; 1:15 to 15:1, 1:10 to 10:1; 10:1 to 1:2, and 5:1 to 3:1;
c) when combined, have a net charge selected from the ranges comprising −5 to +5 meq/g, 0 to +5 meq/g, and +1 to +3.5;
d) are added during said process in a manner selected from adding the aqueous cationic GPAM and APP solutions (i) simultaneously; (ii) sequentially in either order; (iii) together as a pre-mixed solution; and (iv) any combination thereof;
e) are added during said process in a manner selected from adding said aqueous cationic GPAM and APP solutions (i) to said aqueous fiber stock comprising cellulosic fibers at the wet end of a paper machine prior to formation of said paper product; (ii) to a forming cellulosic fiber web during formation of said paper product; (iii) to one or more surfaces of said paper product after formation of said paper product; and (iv) any combination thereof;
f) when added to said aqueous fiber stock comprising cellulosic fibers, are added to obtain a dosage of said at least one cationic GPAM selected from the ranges comprising 0.5-25, 3-12, 6-10 lb/ton of dry fibers and a dosage of said at least one anionic polysaccharide promoter selected from the ranges comprising 0.5-15, 1-8, and 2-5 lb/ton of dry fibers; and/or
g) are added during said process, wherein points of addition include, but are not limited to, before refining the pulp, after refining the pulp, at the fan pump, before the head box, at the head box, by spraying, printing, coating, and impregnating onto the web, to preformed paper, for example by tub sizing, and on the dried paper sheets, for example by spraying, and any combination thereof.

In some embodiments, the at least one cationic GPAM:
a) comprises a glyoxal:base polymer weight ratio range selected from 1:99 to 50:50 and 5:95 to 20:80;
b) is obtained by reaction of glyoxal with said high molecular weight base polymer, wherein said high molecular weight base polymer comprises an acrylamide-based copolymer comprising neutral monomers, cationic monomers, and optionally anionic monomers, further wherein
   i) the neutral monomers are selected from the group of primary amide-containing monomers comprising acrylamide, methacrylamide, ethyl acrylamide, crotonamide, N-methyl acrylamide, N-butyl acrylamide, N-ethyl methacrylamide, and any combination thereof;
   ii) the cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) the optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent cationic monomer content ranging from 5-60% by weight, a percent anionic monomer content ranging from 0-50% by weight, and the remainder of the monomer content is nonionic; and/or
d) has a cationic charge density range selected from the ranges comprising 0.4-5 meq/g, 1-4 meq/g, and 1.4-2 meq/g at pH 8.0.

In some embodiments, the at least one anionic polymeric promoter comprises one or more of the following:
a) has a weight average molecular weight selected from at least 10 kDa, at least 50 kDa, at least 100 kDa, at least 250 kDa, and 10-1000 kDa;
b) comprises a copolymer comprising neutral monomers, anionic monomers, and optionally cationic monomers, wherein
   i) the neutral monomers are selected from the group of vinyl monomers comprising acrylamide-based monomers, including but not limited to, acrylamide, methacrylamide, ethyl acrylamide, crotonamide, N-methyl acrylamide, N-butyl acrylamide, N-ethyl methacrylamide, and any combination thereof; acrylate-based monomers including esters thereof; N-vinylcarbamides; styrene; acrylonitrile; vinyl acetate; N-vinylpyrrolidone; N-vinyl-2-caprolactam; maleic anhydride; vinylethers; and any combinations thereof;
   ii) the cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) the optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent anionic monomer content ranging from 2-60% by weight, a percent cationic monomer content ranging from 0-50% by weight, and the remainder of the monomer content is nonionic; and/or
d) has an anionic charge density range selected from the ranges comprising −10 to 4 meq/g, −8 to 2 meq/g, and −4 to −1 meq/g at pH 8.0.

In some embodiments, the fiber stock comprising cellulosic fibers comprise one or more of the following:
a) comprises an aqueous slurry of cellulosic fibers obtained from sources selected from softwood fiber, hardwood fiber, recycled fiber, refined fiber, mill broke fibers, non-wood fibers, including but not limited to straw and wheat pulp, and a mixture of any of the foregoing;
b) optionally comprises pulp selected from Kraft pulp, bleached pulp, unbleached pulp, process water from pulp, paper, and/or board production, neutral sulfite semi chemical (NSSC) pulp, mechanical pulp, and a mixture of any of the foregoing;
c) optionally comprises a stock selected from a thick stock, a thick stock diluted with chemical water, synthetic water, white water, and/or process water, and a thin stock, and a mixture of any of the foregoing; and/or
d) has a pH selected from the ranges comprising 4.0-9.0, 5.0-8.0, and 5.5-7.0.

In exemplary embodiments,
a) the at least one cationic GPAM comprises a high molecular weight base polymer comprising a copolymer of (i) cationic monomers selected from DADMAC, AETAC, and combinations thereof; (ii) nonionic monomers selected from acrylamide, methacrylamide, and combinations thereof; and (iii) optionally anionic monomers selected from acrylic acid, its corresponding water soluble salts thereof, water dispersible alkali metal salts, alkaline earth metal salts, ammonium salts, and combinations thereof; and
b) the at least one anionic polymeric promoter comprises a copolymer of acrylamide and acrylic acid, its corresponding water soluble salts thereof, water dispersible alkali metal salts, alkaline earth metal salts, ammonium salts, and combinations thereof.

In some embodiments, the process results in formation of a paper product. In some embodiments, the paper product comprises one or more of the following:
a) comprises a percent by weight of said at least one cationic GPAM comprising a high molecular weight base polymer selected from the ranges comprising 0.02-10% and 0.05-5% of the dry paper weight;
b) comprises a percent by weight of said at least one anionic polymeric promoter selected from the ranges comprising 0.02-10% and 0.05-5% of the dry paper weight;
c) exhibits (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa); and/or
d) is selected from the list of paper products comprising a cellulose paperboard web which optionally comprises predominantly cellulose fibers and a fiber-based product including, but not limited to, handsheets, board-based products, beverage carriers, toweling, milk and juice cartons, food trays, paper bags, liner board for corrugated containers, packaging board grade, tissue and towel grade, paper materials, paper towels, diapers, sanitary napkins, training pants, pantiliners, incontinence briefs, tampons, pee pads, litter box liners, coffee filters, air filters, dryer pads, floor cleaning pads, absorbent facial tissue, absorbent bathroom tissue, napkins, wrapping paper, paperboard cartons, bag paper, and other paper products of the like.

The invention also provides a paper product comprising one or more compositions or combinations of (a) and (b) for strengthening paper or board obtainable by a process disclosed herein. In some embodiments, the paper product comprises one or more of the following:
a) comprises a percent of said at least one cationic GPAM comprising a high molecular weight base polymer selected from the ranges comprising 0.02-10% by weight and 0.05-5% by weight of the dry paper product;
b) comprises a percent of said at least one anionic polymeric promoter selected from the ranges comprising 0.02-10% by weight and 0.05-5% by weight of the dry paper product;
c) exhibits (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa); and/or
d) is selected from the list of paper products comprising a cellulose paperboard web which optionally comprises predominantly cellulose fibers and a fiber-based product including, but not limited to, handsheets, board-based products, beverage carriers, toweling, milk and juice cartons, food trays, paper bags, liner board for corrugated containers, packaging board grade, tissue and towel grade, paper materials, paper towels, diapers, sanitary napkins, training pants, pantiliners, incontinence briefs, tampons, pee pads, litter box liners, coffee filters, air filters, dryer pads, floor cleaning pads, absorbent facial tissue, absorbent bathroom tissue, napkins, wrapping paper, paperboard cartons, bag paper, and other paper products of the like.

### BRIEF DESCRIPTION OF THE DRAWINGS

The invention will be described in more detail with reference to appended drawings, described in detail below.

FIG. 1A-B provides exemplary pictures of reject pulp particles from a repulping study according to Example 4. FIG. 1A shows repulping rejects of paper made using the inventive combination of high molecular weight cationic GPAM with APP. FIG. 1B shows repulping rejects of paper made using PAE. Screens from left to right are 12 mesh, 18 mesh, and 20 mesh.

### DETAILED DESCRIPTION OF THE INVENTION

Before describing the invention, the following definitions are provided. Unless stated otherwise all terms are to be construed as they would be by a person skilled in the art.

### Definitions

As used herein, the singular forms “a”, “and”, and “the” include plural referents unless the context clearly dictates otherwise. All technical and scientific terms used herein have the same meaning as commonly understood to one of ordinary skill in the art to which this invention belongs unless clearly indicated otherwise.

As used herein, the terms “papermaking process” and “papermaking application” generally refers to any process in which any form of paper and/or paperboard product may be produced. For example, such processes include making paper products from pulp, such as methods comprising forming an aqueous cellulosic papermaking furnish, draining the furnish to form a sheet, and drying the sheet. The steps of forming the papermaking furnish, draining and drying may be carried out in any conventional manner generally known in the art. In some instances, papermaking processes and applications may comprise the use of one or more polymer solutions, wherein said polymer solutions may comprise one or more cationic starches, one or more DPAMs, one or more CPAMs, one or more GPAMs, one or more anionic dry polyacrylamides (ADPAM), and/or one or more polyaminoamide-epichlorohydrin (PAE) resins, for example as paper strengthening agents and/or wet-strength agents.

As used herein, the term “fiber” refers to the basic structural unit of paper or board.

As used herein, the terms “recycled fiber” and “recovered fiber”, refer to paper, paperboard, and fibrous wastes from retail stores, office buildings, homes, manufacturing plants, and so forth, after they have passed through their end-usage as a consumer item. Manufacturing wastes include: dry paper and paperboard waste generated after completion of the papermaking process including by way of example: envelope cuttings, bindery trimmings, and other paper and paperboard waste resulting from printing, cutting, forming, and other converting operations; bag, box, and carton manufacturing wastes; mill wrappers, and rejected unused stock; and repulped finished paper and paperboard from obsolete inventories of paper and paperboard manufacturers, merchants, wholesalers, dealers, printers, converters, or others. In particular the term “recycled fibers” includes recycled fibers derived by processing of paper and other consumer cellulosic materials, e.g., paper, old corrugated containerboard (OCC), mixed office waste (MOW), old magazine (OMG), unbleached kraft pulp, neutral sulphite semi chemical (NCCS) pulp and/or mechanical pulp. Source materials for recycled fibers may be selected from old corrugated containerboard, mixed office waste, old newsprint, old magazines, double liner kraft, and any mixtures thereof. Mixed waste (MXW) denotes recycled mixture of recycled board, such as OCC, white lined chipboard and/or folding boxboard, and recycled paper, such as old newsprint, old magazines and/or office waste papers. Mixed office waste denotes recycled fiber material mainly containing copying papers, printer papers and offset papers. Double lined kraft denotes recycled fiber material comprising clean sorted unprinted corrugated cardboard cartons, boxes, sheet or trimmings, e.g. of kraft or jute liner. White lined chipboard (WLC) denotes multiply board comprising deinked fiber material and/or un-deinked recycled fiber material originating e.g., from OCC, mixed office waste or old newspapers (ONP) in or more of the layers. Presence of any of these recycled fiber materials in the fiber suspension usually decreases drainage and paper strength and provides a substantial load of starch, hydrophobic, and colloidal substances to the process.

As used herein, the term “OCC” refers to old corrugated cardboard and/or containerboard. Corrugated refers to those boxes where the materials are made from three separate layers of paper, two liners and a corrugated, or wavy, layer sandwiched between them. Brown paper bags are commonly accepted with OCC for recycling. The term OCC denotes recycled fiber material which have liners of test liner, jute or kraft, and may cover also double sorted corrugated containerboard (DS OCC).

As used herein, the terms “broke” or “mill broke” refer to paper, which during the paper making process becomes suitable only for repulping e.g., trimmings or paper that is out of specification. Broke is re-used material which never left the mill is not regarded as recycled or recovered. Broke is a valuable source of fiber and is recycled internally at the mill.

As used herein, the term “coated broke” refers to broke that contains coatings that are applied to the base sheet of paper as it is being manufactured. When the broke contains these coatings, it presents special problems in recycling to recover fiber values because the coatings introduce materials which would not normally be present in the original stock of fiber used to manufacture the base paper sheet. The coated broke may also contain dyes and/or other additives. In the present application coated broke includes surface-sized, dyed, and/or creped broke.

As used herein, the term “recycled fiber composition” generally refers to a composition comprising recycled cellulosic fibers, typically a composition wherein most or all are recycled fibers, e.g., at least 40, 50, 60, 70, 80, 90 or 100%.

As used herein, the term “fiber suspension” is understood as an aqueous suspension, which comprises fibers, preferably recycled fibers, and optionally fillers. For example, the fiber suspension may comprise at least 5%, preferably 10-30%, more preferably 11-19% of mineral filler. Mineral filler may be any filler conventionally used in paper and board manufacturing, such as ground calcium carbonate, precipitated calcium carbonate, clay, talc, gypsum, titanium dioxide, synthetic silicate, aluminum trihydrate, barium sulphate, magnesium oxide or their any of mixtures.

As used herein, the term “slurry” generally refers to a mixture of water, dissolved paper pulp, and optionally other soluble or insoluble components produced or added during the stock preparation phase of papermaking.

As used herein, the terms “furnish” or “papermaking furnish” generally refers to a mixture of cellulosic fibers, pulp, optional fillers, dyes, and water from which paper or board is made.

As used herein, the term “thick stock” generally refers to mixture of papermaking pulp and other materials with a consistency of about 1 to 5%.

As used herein, the term “thin stock” generally refers to a mixture of papermaking pulp and other materials, after having been diluted to a consistency below 1% with whitewater or other process water at a fan pump.

As used herein, the term “white water” generally refers to process water within a paper machine system, especially referring to water that is drained from paper as the sheet is being formed.

As used herein, the terms “fixation”, “fixing” and “fix” means that a substance is associated or attached onto the fibers at least temporarily or permanently.

As used herein, the term “flocculation” generally refers to the tendency for fibers to collect together in bunches in the presence of flow, and especially in the presence of retention aids; the same word also refers to the action of high-mass polymers in forming bridges between suspended colloidal particles, causing strong, relatively irreversible agglomeration.

The term “flocculant” may generally refer to a reagent that may bridge neutralized or facilitate coagulation of particles into larger agglomerates, typically resulting in more efficient settling. Flocculation process generally involves addition of a flocculant followed by mixing to facilitate collisions between particles, allowing for the destabilized particles to agglomerate into larger particles that can be removed by gravity through sedimentation or by other means, e.g., centrifugation, filtration, and the like.

As used herein, the terms “polymer” or “polymeric additives” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, for example, polymerizing, a particular monomer. Unless otherwise specified, a polymer may also comprise a “copolymer” that may comprise two or more different recurring units that may be formed by, for example, copolymerizing, two or more different monomers, and/or by chemically modifying one or more recurring units of a precursor polymer. Unless otherwise specified, a polymer or copolymer may also comprise a “terpolymer” which generally refers to a polymer that comprises three or more different recurring units. Any one of the one or more polymers discussed herein may be used in any applicable process, for example, as a strengthening agent or promoter.

As used herein, the term “monomer” generally refers to nonionic monomers, anionic monomers, cationic monomers, zwitterionic monomers, betaine monomers, and amphoteric ion pair monomers.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

As used herein, the term “cationic monomer” generally refers to a monomer that possesses a positive charge or a monomer that is positively charged at a pH within the normal operating range of paper machine processes.

As used herein, the term “nonionic monomer” generally refers to a monomer that possesses a neutral charge.

As used herein, the term “glyoxalation percentage” refers to the percentage of acrylamide-based monomers which are glyoxalated in a polymer of the cationic GPAM composition, e.g., the first base polymer and/or the second base polymer.

As used herein, the term “GPAM content” refers to the sum of the glyoxalated base polymer(s) plus free glyoxal in the cationic GPAM composition.

As used herein, the term “water-soluble” generally refers to polymer products that are fully miscible with water. When mixed with excess of water, the cationic emulsion polymer in the polymer product is preferably fully dissolved and the obtained polymer solution is preferably free from discrete polymer particles or granules.

As used herein, the term “aqueous solution” or “solution” generally refers to a mixture of water and a water-soluble solute or solutes which are completely dissolved. The solution may be homogenous. When mixed with excess of water, the cationic emulsion polymer in the polymer product is preferably fully dissolved and the obtained polymer solution is preferably free from discrete polymer particles or granules.

As used herein, the term “aqueous suspension”, “aqueous slurry”, or “slurry” generally refer to a heterogeneous mixture of a fluid that contains insoluble or sparingly soluble solid particles sufficiently large for sedimentation. Suspensions and slurries of the present invention may also comprise some amount of solid particles, often termed colloidal particles, which do not completely settle or take a long time to settle completely.

As used herein, the terms “polyacrylamide” or “PAM” generally refer to polymers and co-polymers comprising acrylamide moieties, and the terms encompass any polymers or copolymers comprising acrylamide moieties, e.g., one or more acrylamide (co)polymers. In some instances, PAMs may comprise anionic PAMs (APAMs), cationic PAMs (CPAMs), and/or sulfonated PAMs (SPAMs).

As used herein, the term “glyoxalated polyacrylamide” (“GPAM”) generally refers to a polymer obtained by reacting glyoxal and a polyacrylamide base polymer. Methods for producing glyoxalated polyacrylamides are known in the art. (See e.g., U.S. Pat. No. 3,556,932 which first disclosed the synthesis of a GPAM composition prepared by reacting glyoxal with a cationic polyacrylamide). In some instances, the polyacrylamide backbone of the GPAM can incorporate a small amount of a cationic monomer, rendering the polymer self-retaining on fibers. In general, GPAM comprises a reactive polymer that can covalently bind with cellulose upon dehydration.

As used herein, the term “GPAM” generally refers to cationic wet strength resins, which include PAM resins used in the manufacturing of moisture resistant paper grades such as liquid packaging, napkin, and paper towel. Positively charge resins electrostatically adsorb to negatively charged fines and fibers, increasing the global efficiency of the productive process. The term DPAM refers to polyacrylamides that are in dry form, e.g., powder form; CPAM refers to cationic polyacrylamides; GPAM refers to glyoxalated polyacrylamides

As used herein, the term “Poly-DADMAC” refers to poly-diallylmethylammonium chloride, which is a fully charged, cationic polymer often used as the standard for cationic demand titrations.

As used herein, the terms “promoter”, “anionic polymeric promoter”, and “APP” generally refer to any anionic polymeric additive which enhances the ability of a strengthening sizing agent (e.g., cationic GPAM) to strengthen the finished paper product. Promoting agents may also act to impart desirable physical properties to a paper produce, such as enhanced wet strength, dry strength, and wet decay. Promoting agents of the present disclosure includes anionic PAC “APAM” and the like.

As used herein, the term “zeta potential” refers to the average electrical potential at a hydrodynamic slip plane adjacent to a solid surface exposed to a liquid. Zeta potential data provide the papermaker with a way to predict how a furnish is likely to respond to the addition of cationic or anionic additives. The zeta potential is a good predictor of the magnitude of electrical repulsive forces between particles of known size and shape as a function of distance. Slurries of fibers that have high absolute values of zeta potentials (greater than plus or minus 20 mV) are likely to remain in stable dispersion during storage.

As used herein, the terms “wet end of a paper machine” or “wet end” generally refer to the parts of a papermaking process between pulping (or bleaching) and wet-pressing of the paper.

As used herein, the term “consistency” generally refers to percent oven dry mass in the stock, slurry, or furnish (i.e., 100%*oven dry mass/total mass).

The terms, “total solids” or “total suspended solids” are used interchangeably herein and generally refer the total amount or weight of suspended solids contained in oil sands or other sands comprising dispersion. “Total solids” or “total suspended solids” generally does not include dissolved solids.

As used herein, the term “ppm” refers to parts per million on the basis of milligrams of solute per liter of aqueous solution or slurry (e.g., mg/L).

As used herein, the terms “lbs/ton” or “#/T” denote pounds of dry mass of added material (e.g., additive, solute, and/or particle) per ton of suspended solids (e.g., weight of AKD per total dry ton of suspended solids).

As used herein, the terms “kg/t” or “kg/ton” denote kilograms of dry mass (additive, solute, and/or particle) per ton of slurry, stock, and/or furnish.

As used herein, the phrases “% by wt.” denotes pounds of dry mass of additive per dry mass of solids in the formulation, solution, or slurry, multiplied by 100%.

### DESCRIPTION OF THE INVENTION

Glyoxylated polyacrylamide (GPAM) is generally used in a variety of paper grades to enhance the dry and temporary wet strength. It is used for example to increase the initial wet strength of many household tissues which come in contact with water in use. Glyoxylated polyacrylamide is also applied to increase the compression strength and the dimensional stability of many board-grade paper products.

Cationic glyoxalated polyacrylamide is a well-known strength resin that is often regarded as benchmark for generating dry strength. The polyacrylamide backbone normally incorporates a small amount of a cationic monomer, e.g., diallyldimethylammonium chloride (DADMAC), rendering the polymer self-retaining on fibers. GPAM is a reactive polymer that can covalently bind with cellulose upon dehydration. However, the addition of water can rapidly reverse this reaction, leading to the rapid decay of wet strength.

The present disclosure generally encompasses a composition or combination of materials for enhancing the dry and/or wet strength and wet decay of paper or board. This composition or combination may comprise at least one cationic glyoxalated polyacrylamide (“GPAM”) comprising a high molecular weight base polymer; and at least one anionic polymeric promoter (“APP”).

The present disclosure also generally encompasses a process for process for manufacturing one or more paper products with enhanced strength and improved wet decay properties. This process may comprise adding to a fiber stock comprising cellulosic fibers at least one cationic glyoxalated polyacrylamide (“GPAM”) comprising a high molecular weight base polymer; and at least one anionic polymeric promoter (“APP”).

It was surprisingly found that the combination of high molecular weight cationic GPAM with an APP comprising polyacrylamide and acrylate, provided a synergistic increase in wet strength and wet decay of absorbent handsheets. This wet decay for the handsheets falls within a desirable range (10% to 20%) for absorbent paper products such as paper towels, wherein disintegration after wetting is not preferred.

Without being bound to theory, it can be reasoned that the decreased wet decay is likely due to the combination of high dosage level of high molecular weight GPAM and the usage of APP. The synergistic effect may be a result of the effect of APP on zeta potential, a parameter that determines the electrical interaction between particles.

In particular, the results disclosed herein also demonstrate that the combination of high molecular weight cationic GPAM and APP can be used to enhance the strength parameters and repulping performance of one or more paper products, optionally absorbent paper products.

The subject process for preparation of one or more paper products afford one or more of the following advantages: (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa).

The present disclosure provides a composition for strengthening paper or board, optionally an aqueous composition. In some embodiments, the composition comprises at least one cationic glyoxalated polyacrylamide (“GPAM”) comprising a high molecular weight base polymer; and at least one anionic polymeric promoter (“APP”). In some embodiments, the high molecular weight base polymer has a weight average molecular weight selected from at least 50 kDa, at least 80 kDa, at least 100 kDa, at least 250 kDa, and 100-1000 kDa.

The present disclosure also provides a combination of materials. In some embodiments, the combination comprises at least one cationic glyoxalated polyacrylamide (“GPAM”) comprising a high molecular weight base polymer, optionally an aqueous composition; and at least one anionic polymeric promoter (“APP”).

In some embodiments, the high molecular weight base polymer (a) has a weight average molecular weight selected from at least 50 kDa, at least 80 kDa, at least 100 kDa, at least 250 kDa, and 100-1000 kDa. In some embodiments, the combination of materials (a) and (b), when both added separately, simultaneously, or as a pre-mixed combination to a papermaking system comprising a furnish composition or to a furnish composition, which furnish composition comprises cellulosic fibers used for the manufacture of paper or board, wherein (a) and (b) may be added in either order, and result in a paper or board material of enhanced strength compared to when said combination of materials (a) and (b), are not added to the papermaking system or to said furnish composition.

In some embodiments, the at least one cationic GPAM comprises one or more of the following:
a) comprises a glyoxal:base polymer weight ratio range selected from 1:99 to 50:50 and 5:95 to 20:80;
b) is obtained by reaction of glyoxal with said high molecular weight base polymer, wherein the high molecular weight base polymer comprises an acrylamide-based copolymer comprising neutral monomers, cationic monomers, and optionally anionic monomers, further wherein
   i) the neutral monomers are selected from the group of primary amide-containing monomers comprising acrylamide, methacrylamide, ethyl acrylamide, crotonamide, N-methyl acrylamide, N-butyl acrylamide, N-ethyl methacrylamide, and any combination thereof;
   ii) the cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) the optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent cationic monomer content ranging from 5-60% by weight, a percent anionic monomer content ranging from 0-50% by weight, and the remainder of the monomer content is nonionic;
d) has a cationic charge density range selected from the ranges comprising 0.4-5 meq/g, 1-4 meq/g, and 1.4-2 meq/g at pH 8.0;
e) is formulated in a manner selected from (i) as a dry powder and (ii) as an aqueous solution comprising a GPAM solids percent by weight range selected from 1-15%, 2-10%, and 4-8%; and/or
f) when added to a papermaking system or composition comprising cellulosic fibers used for the manufacture of paper or board, is added in a dosage selected from the ranges comprising 0.5-25, 3-12, 6-10 lb./ton of dry fibers.

In some embodiments, the at least one anionic polymeric promoter comprises one or more of the following:
a) has a weight average molecular weight selected from at least 10 kDa, at least 50 kDa, at least 100 kDa, at least 250 kDa, and 10-1000 kDa;
b) comprises a copolymer comprising neutral monomers, anionic monomers, and optionally cationic monomers, wherein
   i) said neutral monomers are selected from the group of vinyl monomers comprising acrylamide-based monomers, including but not limited to, acrylamide, methacrylamide, ethyl acrylamide, crotonamide, N-methyl acrylamide, N-butyl acrylamide, N-ethyl methacrylamide, and any combination thereof; acrylate-based monomers including esters thereof; N-vinylcarbamides; styrene; acrylonitrile; vinyl acetate; N-vinylpyrrolidone; N-vinyl-2-caprolactam; maleic anhydride; vinylethers; and any combinations thereof;
   ii) said cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) said optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent anionic monomer content ranging from 2-60% by weight, a percent cationic monomer content ranging from 0-50% by weight, and the remainder of the monomer content is nonionic, and;
d) has an anionic charge density range selected from the ranges comprising −10 to 4 meq/g, −8 to 2 meq/g, and −4 to −1 meq/g at pH 8.0;
e) is formulated in a manner selected from (i) formulated as a dry powder and (ii) formulated as an aqueous solution comprising an APP solids percent by weight range selected from 1-25%, 2-10%, and 4-8%; and/or
f) when added to a papermaking system or composition comprising cellulosic fibers used for the manufacture of paper or board, is added in a dosage selected from the ranges comprising 0.5-15, 1-8, and 2-5 lb./ton of dry fibers.

In certain embodiments, the composition or combination of (a) and (b):
a) when combined is/are formulated in a manner selected from (i) at least one dry powder (ii) at least one aqueous solution;
b) when combined has a ratio by weight of GPAM:APP (dry:dry) selected from the ranges comprising 1:20 to 20:1, 1:15 to 15:1, 1:10 to 10:1, 10:1 to 1:2, and 5:1 to 3:1; and/or
c) when combined has a net charge selected from the ranges comprising −5 to +5 meq/g, 0 to +5 meq/g, and +1 to +3.5.

In exemplary embodiments, the at least one cationic GPAM comprises a high molecular weight base polymer comprising a copolymer of (i) cationic monomers selected from DADMAC, AETAC, and combinations thereof; (ii) nonionic monomers selected from acrylamide, methacrylamide, and combinations thereof; and (iii) optionally anionic monomers selected from acrylic acid, its corresponding water soluble salts thereof, water dispersible alkali metal salts, alkaline earth metal salts, ammonium salts, and combinations thereof; and the at least one anionic polymeric promoter comprises a copolymer of acrylamide and acrylic acid, its corresponding water soluble salts thereof, water dispersible alkali metal salts, alkaline earth metal salts, ammonium salts, and combinations thereof.

In exemplary embodiments, the composition or combination when added to a papermaking system or composition comprising cellulosic fibers used for the manufacture of paper or board, results in a paper product comprising one or more of the following properties:
a) a percent of GPAM solids selected from the ranges comprising 0.02-10% by weight and 0.05-5% by weight of the dry paper product;
b) a percent of anionic polymeric promoter solids selected from the ranges comprising 0.02-10% by weight and 0.05-5% by weight of the dry paper product; and/or
c) (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa).

The invention also provides a furnish composition for the manufacture of paper or board, which has been treated with at least one strengthening system selected from the composition for strengthening paper or board and the combination of materials. In some embodiments, the furnish composition comprises an aqueous slurry of fiber stock comprising cellulosic fibers, and further comprises one or more of the following:
a) an aqueous slurry of cellulosic fibers optionally obtained from sources selected from softwood fiber, hardwood fiber, recycled fiber, refined fiber, mill broke fibers, non-wood fibers, including but not limited to straw and wheat pulp, and a mixture of any of the foregoing;
b) pulp selected from Kraft pulp, bleached pulp, unbleached pulp, process water from pulp, paper, and/or board production, neutral sulfite semi chemical (NSSC) pulp, mechanical pulp, and a mixture of any of the foregoing; and/or
c) a stock selected from a thick stock, a thick stock diluted with chemical water, synthetic water, white water, and/or process water, and a thin stock, and a mixture of any of the foregoing.

In some embodiments, the amount of the at least one strengthening system, when added to a papermaking system comprising the furnish composition and/or to the furnish composition is sufficient to improve the strength properties of paper or board produced from said furnish composition compared to when said strengthening system is not added to the papermaking system comprising the furnish composition or to the furnish composition.

The present disclosure also generally encompasses a papermaking process for manufacturing one or more paper products, optionally one or more absorbent paper products, from a fiber stock comprising cellulosic fibers. In some embodiments, the process includes the addition of:
a) at least one cationic glyoxalated polyacrylamide (“GPAM”) comprising a high molecular weight base polymer, wherein said high molecular weight base polymer has a weight average molecular weight selected from at least 50 kDa, at least 80 kDa, at least 100 kDa, at least 250 kDa, and 100-1000 kDa; and
b) at least one anionic polymeric promoter (“APP”).

In some embodiments, (a) and (b) are both added separately or in combination during said papermaking process at one or more time points during papermaking selected from any time before, during, and after the paper product is formed; and/or (a) and (b) are both added separately or in combination at one or more locations in the paper making system; and/or (a) and (b) may be added as separate compositions in either order or are added as a pre-mixed composition comprising (a) and (b), optionally an aqueous composition, further optionally wherein if (a) and (b) are added separately the addition of (a) and (b) is simultaneous or proximate in time, e.g., (a) and (b) are added within one hour, 30 minutes, 10 minutes, 1 minute, or less than 1 minute of each other.

In some embodiments, the at least one cationic GPAM and the at least one anionic polymeric promoter comprises one or more of the following:
a) are formulated as dry polymers or as aqueous solutions, each solution having a solids percent by weight range selected from the ranges comprising 1-25%, 1-15%, 2-10%, and 4-8%;
b) are added during said process to obtain a ratio by weight of GPAM:APP (dry:dry) selected from the ranges comprising 1:20 to 20:1; 1:15 to 15:1, 1:10 to 10:1; 10:1 to 1:2, and 5:1 to 3:1;
c) when combined, have a net charge selected from the ranges comprising −5 to +5 meq/g, 0 to +5 meq/g, and +1 to +3.5;
d) are added during said process in a manner selected from adding the aqueous cationic GPAM and APP solutions (i) simultaneously; (ii) sequentially in either order; (iii) together as a pre-mixed solution; and (iv) any combination thereof;
e) are added during said process in a manner selected from adding said aqueous cationic GPAM and APP solutions (i) to said aqueous fiber stock comprising cellulosic fibers at the wet end of a paper machine prior to formation of said paper product; (ii) to a forming cellulosic fiber web during formation of said paper product; (iii) to one or more surfaces of said paper product after formation of said paper product; and (iv) any combination thereof;
f) when added to said aqueous fiber stock comprising cellulosic fibers, are added to obtain a dosage of said at least one cationic GPAM selected from the ranges comprising 0.5-25, 3-12, and 6-10 lb/ton of dry fibers and a dosage of said at least one anionic polysaccharide promoter selected from the ranges comprising 0.5-15, 1-8, and 2-5 lb/ton of dry fibers; and/or
g) are added during said process, wherein points of addition include, but are not limited to, before refining the pulp, after refining the pulp, at the fan pump, before the head box, at the head box, by spraying, printing, coating, and impregnating onto the web, to preformed paper, for example by tub sizing, and on the dried paper sheets, for example by spraying, and any combination thereof.

In some embodiments, the at least one cationic GPAM comprises one or more of the following:
a) comprises a glyoxal:base polymer weight ratio range selected from 1:99 to 50:50 and 5:95 to 20:80;
b) is obtained by reaction of glyoxal with said high molecular weight base polymer, wherein said high molecular weight base polymer comprises an acrylamide-based copolymer comprising neutral monomers, cationic monomers, and optionally anionic monomers, further wherein
   i) the neutral monomers are selected from the group of primary amide-containing monomers comprising acrylamide, methacrylamide, ethyl acrylamide, crotonamide, N-methyl acrylamide, N-butyl acrylamide, N-ethyl methacrylamide, and any combination thereof;
   ii) the cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) the optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent cationic monomer content ranging from 5-60% by weight, a percent anionic monomer content ranging from 0-50% by weight, and the remainder of the monomer content is nonionic; and/or
d) has a cationic charge density range selected from the ranges comprising 0.4-5 meq/g, 1-4 meq/g, and 1.4-2 meq/g at pH 8.0.

In some embodiments, the at least one anionic polymeric promoter comprises one or more of the following:
a) has a weight average molecular weight selected from at least 10 kDa, at least 50 kDa, at least 100 kDa, at least 250 kDa, and 10-1000 kDa;
b) comprises a copolymer comprising neutral monomers, anionic monomers, and optionally cationic monomers, wherein
   i) the neutral monomers are selected from the group of vinyl monomers comprising acrylamide-based monomers, including but not limited to, acrylamide, methacrylamide, ethyl acrylamide, crotonamide, N-methyl acrylamide, N-butyl acrylamide, N-ethyl methacrylamide, and any combination thereof; acrylate-based monomers including esters thereof; N-vinylcarbamides; styrene; acrylonitrile; vinyl acetate; N-vinylpyrrolidone; N-vinyl-2-caprolactam; maleic anhydride; vinylethers; and any combinations thereof;
   ii) the cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
   iii) the optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
c) has a percent anionic monomer content ranging from 2-60% by weight, a percent cationic monomer content ranging from 0-50% by weight, and the remainder of the monomer content is nonionic; and/or
d) has an anionic charge density range selected from the ranges comprising −10 to 4 meq/g, −8 to 2 meq/g, and −4 to −1 meq/g at pH 8.0.

In some embodiments, the fiber stock comprising cellulosic fibers comprises one or more of the following:
a) comprises an aqueous slurry of cellulosic fibers obtained from sources selected from softwood fiber, hardwood fiber, recycled fiber, refined fiber, mill broke fibers, non-wood fibers, including but not limited to straw and wheat pulp, and a mixture of any of the foregoing;
b) optionally comprises pulp selected from Kraft pulp, bleached pulp, unbleached pulp, process water from pulp, paper, and/or board production, neutral sulfite semi chemical (NSSC) pulp, mechanical pulp, and a mixture of any of the foregoing;
c) optionally comprises a stock selected from a thick stock, a thick stock diluted with chemical water, synthetic water, white water, and/or process water, and a thin stock, and a mixture of any of the foregoing; and
d) has a pH selected from the ranges comprising 4.0-9.0, 5.0-8.0, and 5.5-7.0.

In exemplary embodiments, the
a) at least one cationic GPAM comprises a high molecular weight base polymer comprising a copolymer of (i) cationic monomers selected from DADMAC, AETAC, and combinations thereof; (ii) nonionic monomers selected from acrylamide, methacrylamide, and combinations thereof; and (iii) optionally anionic monomers selected from acrylic acid, its corresponding water soluble salts thereof, water dispersible alkali metal salts, alkaline earth metal salts, ammonium salts, and combinations thereof; and
b) at least one anionic polymeric promoter comprises a copolymer of acrylamide and acrylic acid, its corresponding water soluble salts thereof, water dispersible alkali metal salts, alkaline earth metal salts, ammonium salts, and combinations thereof.

In some embodiments, the process results in formation of a paper product. In some embodiments, the paper product comprises one or more of the following:
a) comprises a percent by weight of said at least one cationic GPAM comprising a high molecular weight base polymer selected from the ranges comprising 0.02-10% and 0.05-5% of the dry paper weight;
b) comprises a percent by weight of said at least one anionic polymeric promoter selected from the ranges comprising 0.02-10% and 0.05-5% of the dry paper weight;
c) exhibits (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa); and/or
d) is selected from the list of paper products comprising a cellulose paperboard web which optionally comprises predominantly cellulose fibers and a fiber-based product including, but not limited to, handsheets, board-based products, beverage carriers, toweling, milk and juice cartons, food trays, paper bags, liner board for corrugated containers, packaging board grade, tissue and towel grade, paper materials, paper towels, diapers, sanitary napkins, training pants, pantiliners, incontinence briefs, tampons, pee pads, litter box liners, coffee filters, air filters, dryer pads, floor cleaning pads, absorbent facial tissue, absorbent bathroom tissue, napkins, wrapping paper, paperboard cartons, bag paper, and other paper products of the like.

The invention also provides a paper product comprising one or more compositions or combinations of (a) and (b) for strengthening paper or board obtainable by a process disclosed herein. In some embodiments, the paper product:
a) comprises a percent of said at least one cationic GPAM comprising a high molecular weight base polymer selected from the ranges comprising 0.02-10% by weight and 0.05-5% by weight of the dry paper product;
b) comprises a percent of said at least one anionic polymeric promoter selected from the ranges comprising 0.02-10% by weight and 0.05-5% by weight of the dry paper product;
c) exhibits (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa); and
d) is selected from the list of paper products comprising a cellulose paperboard web which optionally comprises predominantly cellulose fibers and a fiber-based product including, but not limited to, handsheets, board-based products, beverage carriers, toweling, milk and juice cartons, food trays, paper bags, liner board for corrugated containers, packaging board grade, tissue and towel grade, paper materials, paper towels, diapers, sanitary napkins, training pants, pantiliners, incontinence briefs, tampons, pee pads, litter box liners, coffee filters, air filters, dryer pads, floor cleaning pads, absorbent facial tissue, absorbent bathroom tissue, napkins, wrapping paper, paperboard cartons, bag paper, and other paper products of the like.

Having described the invention in detail the invention is further described in the following examples.

### EXAMPLES

The following examples are presented for illustrative purposes only and are not intended to be limiting.

### Example 1: Use of High Molecular Weight Cationic GPAM and APP for Strengthening Handsheets

To determine the effectiveness of cationic glyoxalated polyacrylamide (“GPAM”) comprising a high molecular weight base polymer and an anionic polymeric promoter (“APP”) for strengthening paper or board products, two GPAM samples and two APP samples were prepared and used for strengthening handsheets.

### Cationic GPAM and APP Preparation

GPAM 1 and GPAM 2 were prepared by reacting glyoxal with a cationic base polymer copolymer of acrylamide and DADMAC to achieve a glyoxal to base polymer ratio by weight ranging from 5:95 to 10:90. Both GPAM 1 and GPAM 2 had the same monomer composition and the same charge density of +1.7 meq/g.

Polymer molecular weights were measured using gel permeation chromatography. Molecular weight calculations were carried out using a calibration based on polyethylene oxide standards. The GPAM 1 base polymer had a weight average molecular weight (MW) of 10 kDa and GPAM 2 base polymer had a weight average molecular weight of 250 kDa.

APP 1 and APP 2 were prepared as copolymers of acrylamide and acrylic acid. APP 1 contained about 10 wt % of acrylic acid, and APP 2 contained about 50 wt % of acrylic acid. Both APP products had a weight average molecular weight around 300 kDa, as determined by gel permeation chromatography. GPAM and APP samples are listed in Table 1.

GPAM samples were formulated as aqueous solutions containing approximately 10.5 to 12% by weight (GPAM 1) and 5.5 to 6% by weight (GPAM 2) of solid content. APP samples were formulated as aqueous solutions containing approximately 20% by weight (APP 1) and 16% by weight (APP 2) of solid content.

TABLE 1
GPAM and APP samples

| Sample | MW | | Description |
|---|---|---|---|
| GPAM 1 | 10 | kDa | Low MW cationic GPAM |
| GPAM 2 | 250 | kDa | High MW cationic GPAM |
| APP 1 | 300 | kDa | APP with 10% acrylic acid |
| APP 2 | 300 | kDa | APP with 50% acrylic acid |

### Handsheet Preparation

A thick stock consisting of 30% of softwood and 70% hardwood of virgin bleached Kraft pulp was prepared. Both hardwood and softwood were refined to about 450 to 550 CSF before blending together. The final freeness was about 450 to 500 CSF.

Synthetic water was prepared using 150 ppm of sulfate ion and 35 ppm of calcium ion to achieve a conductivity of 550 to 600 μS/cm. After preparation, the synthetic water was used to dilute the aforementioned thick stock to about 0.45% to 0.62% consistency. After dilution, the pH value of the stock was adjusted to the desired value (˜5.5 or ˜7.0).

The inventive strengthening system was prepared by treating portions of the thick stock with cationic GPAM 1 (MW 10 kDa), cationic GPAM 2 (MW 250 kDa), or polyamidoamine epichlorohydrin (PAE) at dosage levels of 0, 3, 6, 9, and 12 lb/ton, where lb/ton denotes pounds of dry polymer per ton of solid in the thick stock. PAE is the industrial standard cationic polymer for enhancing wet strength in handsheet and similar products and was used as a basis for comparison. The resulting slurries were then treated with APP 1 or APP 2 at dosage levels of 0, 0.67, 1, 1.33, 2, 3, 4, and 5 lb/ton. All slurries were mixed thoroughly during polymer addition.

After combining, the ratio by weight of GPAM:APP (dry:dry) was about 4:1 and the net charge of the combination was +1 to +3.5 meq/g.

The chemical addition sequence and mixing time are summarized as follows:
@−45 seconds, add GPAM 1, GPAM 2, or PAE.
@−30 seconds, add APP 1 or APP 2, if used.
@−0 seconds, stop mixer and make handsheet.

Handsheets (approximately 80 g/m2) were prepared according to the standard handsheet protocol of the Dynamic Sheet Former (DSF). GPAM or PAE was first. After chemically treating the furnish an aliquot of 225 to 250 mL was taken out to measure the zeta potential of the fiber, and the remaining stock was to make an 18-gram sheet. Sheets were pressed with a pneumatic roll press (set at 15 psi), and drum-dried (set at 240° F. for 60 second total drying time). The sheets were also cured in a forced air oven set at 105° C. for 5 minutes.

Before testing, the paper samples were conditioned over night at 23° C. and 50% relative humidity. This follows the TAPPI T 402 om-93 Standard Conditioning and Testing Atmospheres for Paper, Board, Pulp, Handsheet, and Related Products method.

### Example 2: Comparison of GPAM 1 and GPAM 2 for Strengthening Handsheets

To determine the effect of molecular weight of the cationic GPAM on handsheet strength, testing was performed on handsheets prepared according to Example 1 using cationic GPAM 1 (low MW) or GPAM 2 (high MW) combined with APP 1. PAE was used as a basis for comparison. An essential function of APAM 1 was to keep the system zeta potential anionic. Zeta potential is the parameter that determines the electrical interaction between particles, a high value, positive or negative, prevents flocculation. The pH of the pulp was adjusted to about 6.94. The conductivity of the system was about 600 μS/cm.

Handsheets were tested to determine the cross directional (CD) dry tensile strength (DT), immediate wet tensile strength (IWT), and permanent wet tensile strength (PWT) as detailed below.

### Dry Tensile Strength (DT)

Tensile strength was measured by applying a constant-rate-of-elongation to a sample and recording three tensile breaking properties of paper and paper board. The three properties included (i) the force per unit width required to break a specimen (tensile strength), (ii) the percentage elongation at break (stretch) and (iii) the energy absorbed per unit area of the specimen before breaking (tensile energy absorption). Only dry tensile strength measurement is reported herein. This method is applicable to all types of paper, but not to corrugated board. This procedure references TAPPI Test Method T494. Twelve measurements were taken on cross directions per condition and average values were reported. All results were normalized to 80 g/m2 basis weight. A Thwing-Albert QC3A tensile tester was used for this study.

### Immediate Wet Tensile Strength (IWT)

This test method was used to determine the wet tensile strength of paper and paperboard immediately after deionized water was brushed onto both sides of a paper sample. The wet tensile breaking strength is useful in the evaluation of the performance characteristics of tissue products, paper towels, bags and other papers subjected to stress during processing or used while wet. This method references TAPPI TEST Method T456. Eight measurements were taken per condition on cross directions. A Thwing-Albert QC3A tensile tester was used. All results are normalized to 80 g/m2 basis weight.

Permanent Wet Tensile Strength after 30 Minute Soak (PWT)

Tensile strength was measured by wetting the sample handsheet strips in deionized water for 30 minutes, removing excess water from the specimen, and then applying a constant-rate-of-elongation to the specimen and recording the force per unit width required to break the specimen. This is the tensile strength, which is the maximum tensile stress developed in the test specimen before rupture. This method is applicable most commonly on paper towel and paper board. This procedure references TAPPI Test Method T576. Eight measurements were taken per condition for 30 minutes soak in DI water, and four measurement were taken per condition for the 30 minutes soak in 300 ppm alkalinity water. A Thwing-Albert QC3A tensile tester was used. All results are normalized to 80 g/m2 basis weight.

### W/D and Wet Decay

The values for IWT and DT were used to calculate the wet to dry strength percentage (W/D=IWT/DT×100%). The values for PWT and IWT were used to calculate the percent strength decay after wetting (Wet Decay=1−(PWT/IWT)×100%).

Results for the cross directional (CD) dry tensile strength (DT), immediate wet tensile strength (IWT), and permanent wet tensile strength (PWT), W/D, and wet decay are shown in Table 2.

TABLE 2
Handsheet strength testing results comparing GPAM 1 and GPAM 2

| | Dose | | Dose | CD DT | CD IWT | CD PWT | | |
|---|---|---|---|---|---|---|---|---|
| GPAM/PAE | (#/ton) | APP | (#/ton) | (lb/inch) | (lb/inch) | (lb/inch) | W/D | Wet decay |
| Blank | 0.0 | n/a | 0 | 9.19 | 0.3 | 0.13 | 3.1% | 53.9% |
| PAE | 3.0 | n/a | 0 | 10.61 | 1.16 | 0.95 | 10.9% | 17.8% |
| PAE | 6.0 | n/a | 0 | 11.47 | 1.85 | 1.68 | 16.2% | 9.3% |
| PAE | 6.0 | APP 1 | 2 | 11.54 | 1.56 | 1.41 | 13.5% | 9.9% |
| PAE | 9.0 | APP 1 | 3 | 12.68 | 2.24 | 2.05 | 17.7% | 8.6% |
| PAE | 12.0 | APP 1 | 4 | 13.05 | 2.58 | 2.46 | 19.8% | 4.7% |
| GPAM 1 | 6.0 | n/a | 0 | 9.90 | 0.78 | 0.30 | 7.8% | 61.9% |
| GPAM 1 | 6.0 | APP 1 | 2 | 11.39 | 1.38 | 0.93 | 12.1% | 32.3% |
| GPAM 1 | 9.0 | APP 1 | 3 | 12.48 | 1.75 | 1.24 | 14.0% | 28.9% |
| GPAM 1 | 12.0 | APP 1 | 4 | 13.59 | 2.09 | 1.53 | 15.4% | 27.0% |
| GPAM 2 | 3.0 | n/a | 0 | 10.16 | 0.83 | 0.48 | 8.2% | 42.4% |
| GPAM 2 | 6.0 | APP 1 | 2 | 12.32 | 1.61 | 1.23 | 13.1% | 23.5% |
| GPAM 2 | 9.0 | APP 1 | 3 | 13.21 | 1.92 | 1.54 | 14.6% | 19.9% |
| GPAM 2 | 12.0 | APP 1 | 4 | 14.63 | 2.23 | 1.86 | 15.2% | 16.6% |

Results indicate that the combination of APP 1 with cationic strengthening agents, GPAM 1 and GPAM 2, provided significant increase in strength (both dry and wet) and a decrease in wet strength decay over GPAM 1 and GPAM 2 alone. The combination of high MW cationic GPAM 2 with APP 1 provided significantly better strength results (DT, IWT, and PWT) than the combination of lower MW GPAM 1 with APP 1.

It was surprisingly found that the combination of APP 1 with GPAM 1 and GPAM 2 significantly reduced the wet decay over 30 minutes, compared to the GPAM products alone. Several wet decay values for the GPAM 1/APP 1 and GPAM 2/APP 1 combinations fall within a desirable range for paper products such as toilet paper, wherein disintegration after flushing is preferred.

Most notably, the combination of APP 1 with PAE, which is the industry standard wet strength agent, provided very little change in wet decay (˜5% decrease). By contrast, the combination of APP 1 (4 lb/ton) with GPAM 2 (12 lb/ton) unexpectedly and surprisingly reduced wet decay after 30 minutes from 42% to 16.6%. This wet decay value for the GPAM 2/APP 1 combination falls within a desirable range (10% to 20%) for absorbent paper products such as paper towels, wherein disintegration after wetting is not preferred. Without being bound to theory, it can be reasoned that the decreased wet decay is likely due to the combination of higher dosage level GPAM 2 and the usage of APP 1. The synergistic effect may be a result of the effect of APP 1 on zeta potential.

These results provide initial proof of concept that the combination of the high molecular weight cationic GPAM 2 with APP 1 provided unexpected synergistic enhancement in the dry and wet strength of paper products over the combination of PAE with APP 1, indicating a performance benefit for papermaking applications. These results strongly suggest that combination of a higher molecular weight GPAM 2 with anionic promoter is preferred for production of absorbent paper or board.

### Example 3: Comparison of APP 1 and APP 2 for Strengthening Handsheets

To determine the effect of percent anionic content of the APP on the strength properties of handsheets, testing was performed on handsheets prepared according to Example 1 using cationic GPAM 1 (low MW) or GPAM 2 (high MW) combined with APP 1 (10% anionic charge) or APP 2 (50% anionic charge). PAE was used as a basis for comparison.

Handsheets were analyzed for DT, IWT, PWT, W/D, and wet decay by testing according to Example 2. Results are shown in Table 3.

TABLE 3
Handsheet strength testing results comparing APP1 and APP 2

| | Dose | | Dose | | CD DT | CD IWT | CD PWT | | Wet |
|---|---|---|---|---|---|---|---|---|---|
| GPAM/PAE | (#/ton) | APP | (#/ton) | pH | (lb/inch) | (lb/inch) | (lb/inch) | W/D | decay |
| PAE | 6.0 | APP 1 | 2 | 7.0 | 11.60 | 1.58 | 1.39 | 13.6% | 11.7% |
| PAE | 9.0 | APP 1 | 3 | 7.0 | 12.38 | 2.17 | 1.99 | 17.5% | 8.4% |
| PAE | 12.0 | APP 1 | 5 | 7.0 | 13.87 | 2.70 | 2.54 | 19.5% | 5.8% |
| GPAM 2 | 6.0 | APP 1 | 2 | 7.0 | 12.70 | 1.66 | 1.30 | 13.1% | 21.7% |
| GPAM 2 | 9.0 | APP 1 | 3 | 7.0 | 13.48 | 1.93 | 1.62 | 14.3% | 16.4% |
| GPAM 2 | 12.0 | APP 1 | 5 | 7.0 | 14.63 | 2.33 | 2.01 | 15.9% | 14.0% |
| GPAM 2 | 6.0 | APP 2 | 0.67 | 7.0 | 11.88 | 1.26 | 0.93 | 10.6% | 26.8% |
| GPAM 2 | 9.0 | APP 2 | 1.00 | 7.0 | 12.41 | 1.55 | 1.16 | 12.5% | 25.5% |
| GPAM 2 | 12.0 | APP 2 | 1.33 | 7.0 | 12.83 | 1.72 | 1.36 | 13.4% | 21.4% |
| GPAM 1 | 6.0 | APP 1 | 2 | 7.0 | 11.86 | 1.41 | 0.96 | 11.9% | 31.7% |
| GPAM 1 | 9.0 | APP 1 | 3 | 7.0 | 12.71 | 1.77 | 1.25 | 13.9% | 29.1% |
| GPAM 1 | 12.0 | APP 1 | 5 | 7.0 | 14.09 | 2.24 | 1.68 | 15.9% | 25.0% |
| GPAM 1 | 6.0 | APP 2 | 0.67 | 7.0 | 11.03 | 1.10 | 0.59 | 10.0% | 46.5% |
| GPAM 1 | 9.0 | APP 2 | 1.00 | 7.0 | 11.69 | 1.40 | 0.79 | 11.9% | 43.6% |
| GPAM 1 | 12.0 | APP 2 | 1.33 | 7.0 | 12.44 | 1.64 | 0.98 | 13.2% | 40.1% |
| GPAM 2 | 6.0 | APP 1 | 2 | 5.5 | 12.61 | 1.74 | 1.37 | 13.8% | 21.3% |
| GPAM 2 | 9.0 | APP 1 | 3 | 5.5 | 13.80 | 2.05 | 1.69 | 14.8% | 17.2% |
| GPAM 2 | 12.0 | APP 1 | 5 | 5.5 | 15.10 | 2.55 | 2.12 | 16.9% | 16.9% |

Results indicate that both APP samples provided higher strength properties and lower wet strength decay when used with GPAM 2 and GPAM 1. Results suggest that, APAM 1 (10% anionic charge) is more efficient than APP 2 (50% anionic charge) at increasing paper strength properties and decreasing paper wet strength decay. Both APP 1 and APP 2 provided higher strength properties and lower wet strength decay when used with GPAM 2 than with GPAM 1. Overall, the best wet strength decay (14%) was achieved using GPAM 2 and APP 1.

These results provide initial proof of concept that anionic charge density lower than 50% is preferred for strengthening paper or board. These results provide further proof of concept that combination of a higher molecular weight GPAM 2 with anionic promoter is preferred for production of absorbent paper or board.

### Example 4: The Effect of Cationic GPAM and APP on Repulping

Repulping into small, dispersed particles is essential for the recycling of paper or board products. Approximately 100 to 200 mL of total pulp at 1 to 4% consistency was used to make handsheets according to Example 1. A repulping study was carried out using paper samples prepared under two conditions, (i) GPAM 2 (9 lb/ton) with APAM 1 (3 lb/ton) at pH 5.5 and (ii) PAE (9 lb/ton) at pH 7.0 according to Example 1. Both paper samples had comparable permanent wet strength.

The paper samples were torn to about half inch by 1 inch pieces. Deionized water was added and the paper was soaked for one minute. The pH remained unadjusted and repulping was carried out at room temperature without additional adjustment.

Approximately 2.2 dry grams of paper pieces were repulped at 2% using Waring Single Head Drink Mix to simulate hydro-pulper. The Waring mixer was connected to a variable autotransformer and a timer to control the mixing speed and the repulping time. Total repulping time was 60 minutes. At the end of 60 minutes, the pulp suspension (about 100 grams) went through a set of the sieves of 12, 18, and 20 meshes under a running water.

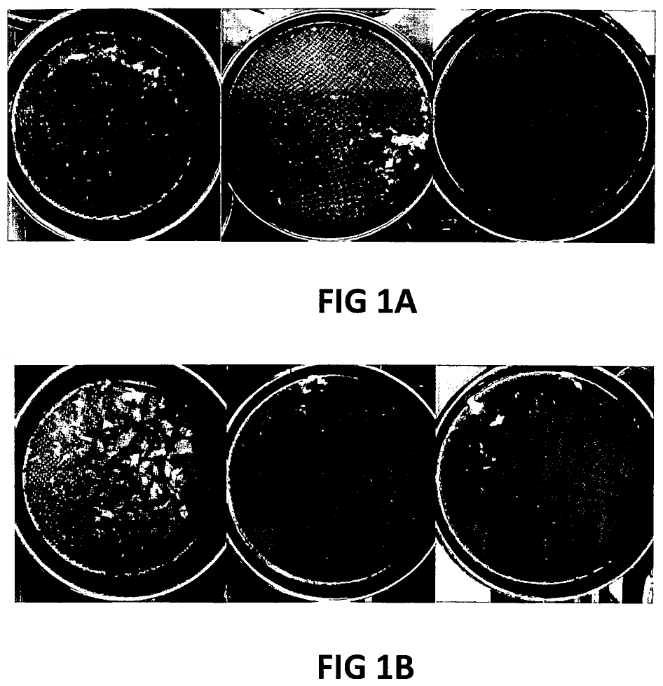

Reject pulp was defined as pulp particles remaining on each screen that could not go through the sieves. Pictures of reject pulp from both pulp suspensions were taken after thorough washing of fibers through the sieves are shown FIG. 1A-B.

FIG. 1A shows rejects of paper made from 9 lb/ton GPAM 2 with 3 lb/ton APAM 1 after 60 min of repulping. FIG. 1B shows rejects of paper made from 9 lb/ton PAE after 60 minutes of repulping. Screens from left to right are 12 mesh, 18 mesh, and 20 mesh.

Results indicate significantly more reject particles from paper prepared using PAE compared to GPAM 2 with APAM 1. The reject PAE particles retained the shape of pieces of paper, whereas the rejects from GPAM 2 with APAM 1 resemble non-dispersed fiber bundles, which are preferred for recycling applications.

This study demonstrates that paper samples prepared with the GPAM 2 and APP 1 combination produces comparable wet strength and higher repulping dispersibility than those prepared with conventional PAE resins. These results strongly indicate that paper prepared with the inventive combination of cationic GPAM and APP will be more amenable to recycling than those prepared with PAE. This is a key advancement for paper manufacturing from recycled fibers.

Having described exemplary embodiments of the invention, the invention is further described in the claims which follow.

What is claimed is:

1. A composition for strengthening paper or board, optionally an aqueous composition, said composition comprising:
(a) at least one cationic glyoxalated polyacrylamide (“GPAM”) comprising a high molecular weight base polymer; and
(b) at least one anionic polymeric promoter (“APP”);
wherein said high molecular weight base polymer has a weight average molecular weight selected from at least 50 kDa, at least 80 kDa, at least 100 kDa, at least 250 kDa, 100-5000 kDa or 100-1000 kDa.

2. A combination of materials, said combination comprising:
(a) at least one cationic glyoxalated polyacrylamide (“GPAM”) comprising a high molecular weight base polymer, optionally an aqueous composition; and
(b) at least one anionic polymeric promoter (“APP”);
wherein said high molecular weight base polymer (a) has a weight average molecular weight selected from at least 50 kDa, at least 80 kDa, at least 100 kDa, at least 250 kDa, 100-5000 kDa or 100-1000 kDa; and
further wherein said combination of materials (a) and (b), when both added separately, simultaneously, or as a pre-mixed combination to a papermaking system comprising a furnish composition or to a furnish composition, which furnish composition comprises cellulosic fibers used for the manufacture of paper or board, wherein (a) and (b) may be added in either order, result in a paper or board material of enhanced strength compared to when said combination of materials (a) and (b), are not added to the papermaking system or to said furnish composition.

3. The composition or combination of claim 1 or 2, wherein said at least one cationic GPAM comprises one or more of the following:
(a) comprises a glyoxal:base polymer weight ratio range selected from 1:99 to 50:50 and 5:95 to 20:80;
(b) is obtained by reaction of glyoxal with said high molecular weight base polymer, wherein said high molecular weight base polymer comprises an acrylamide-based copolymer comprising neutral monomers, cationic monomers, and optionally anionic monomers, further wherein
(i) said neutral monomers are selected from the group of primary amide-containing monomers comprising acrylamide, methacrylamide, ethyl acrylamide, crotonamide, N-methyl acrylamide, N-butyl acrylamide, N-ethyl methacrylamide, and any combination thereof;
(ii) said cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
(iii) said optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
(c) has a percent cationic monomer content ranging from 5-60% by weight, a percent anionic monomer content ranging from 0-50% by weight, and the remainder of the monomer content is nonionic; and
(d) has a cationic charge density range selected from the ranges comprising 0.4-5 meq/g, 1-4 meq/g, and 1.4-2 meq/g at pH 8.0;
(e) is formulated in a manner selected from (i) as a dry powder and (ii) as an aqueous solution comprising a GPAM solids percent by weight range selected from 1-15%, 2-10%, and 4-8%; and/or
(f) when added to a papermaking system or composition comprising cellulosic fibers used for the manufacture of paper or board, is added in a dosage selected from the ranges comprising 0.5-25, 3-12, 6-10 lb./ton of dry fibers.

4. The composition or combination of claim 1, 2 or 3, wherein said at least one anionic polymeric promoter comprises one or more of the following:
(a) has a weight average molecular weight selected from at least 10 kDa, at least 50 kDa, at least 100 kDa, at least 250 kDa, and 10-1000 kDa;
(b) comprises a copolymer comprising neutral monomers, anionic monomers, and optionally cationic monomers, wherein
(i) said neutral monomers are selected from the group of vinyl monomers comprising acrylamide-based monomers, including but not limited to, acrylamide, methacrylamide, ethyl acrylamide, crotonamide, N-methyl acrylamide, N-butyl acrylamide, N-ethyl methacrylamide, and any combination thereof; acrylate-based monomers including esters thereof; N-vinylcarbamides; styrene; acrylonitrile; vinyl acetate; N-vinylpyrrolidone; N-vinyl-2-caprolactam; maleic anhydride; vinylethers; and any combinations thereof;
(ii) said cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
(iii) said optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
(c) has a percent anionic monomer content ranging from 2-60% by weight, a percent cationic monomer content ranging from 0-50% by weight, and the remainder of the monomer content is nonionic;
(d) has an anionic charge density range selected from the ranges comprising −10 to 4 meq/g, −8 to 2 meq/g, and −4 to −1 meq/g at pH 8.0;
(e) is formulated in a manner selected from (i) formulated as a dry powder and (ii) formulated as an aqueous solution comprising an APP solids percent by weight range selected from 1-25%, 2-10%, and 4-8%; and/or
(f) when added to a papermaking system or composition comprising cellulosic fibers used for the manufacture of paper or board, is added in a dosage selected from the ranges comprising 0.5-15, 1-8, and 2-5 lb./ton of dry fibers.

5. The composition or combination of any of the foregoing claims, wherein:
(a) said composition or combination of (a) and (b) when combined is/are formulated in a manner selected from (i) at least one dry powder (ii) at least one aqueous solution;
(b) said composition or combination of (a) and (b) when combined has a ratio by weight of GPAM:APP (dry:dry) selected from the ranges comprising 1:20 to 20:1, 1:15 to 15:1, 1:10 to 10:1, 10:1 to 1:2, and 5:1 to 3:1; and/or
(c) said composition or combination of (a) and (b) when combined has a net charge selected from the ranges comprising −5 to +5 meq/g, 0 to +5 meq/g, and +1 to +3.5.

6. The composition or combination of any of the foregoing claims, wherein
(a) said at least one cationic GPAM comprises a high molecular weight base polymer comprising a copolymer of (i) cationic monomers selected from DADMAC, AETAC, and combinations thereof; (ii) nonionic monomers selected from acrylamide, methacrylamide, and combinations thereof; and (iii) optionally anionic monomers selected from acrylic acid, its corresponding water soluble salts thereof, water dispersible alkali metal salts, alkaline earth metal salts, ammonium salts, and combinations thereof; and
(b) said at least one anionic polymeric promoter comprises a copolymer of acrylamide and acrylic acid, its corresponding water soluble salts thereof, water dispersible alkali metal salts, alkaline earth metal salts, ammonium salts, and combinations thereof.

7. The composition or combination of any of the foregoing claims, wherein said composition or combination when added to a papermaking system or composition comprising cellulosic fibers used for the manufacture of paper or board, results in a paper product comprising one or more of the following properties:
(a) a percent of GPAM solids selected from the ranges comprising 0.02-10% by weight and 0.05-5% by weight of the dry paper product;
(b) a percent of anionic polymeric promoter solids selected from the ranges comprising 0.02-10% by weight and 0.05-5% by weight of the dry paper product; and/or
(c) (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa).

8. A furnish composition for the manufacture of paper or board, which has been treated with at least one strengthening system selected from said composition for strengthening paper or board and said combination of materials according to any of the foregoing claims, wherein said furnish composition comprises an aqueous slurry of fiber stock comprising cellulosic fibers, and further comprises one or more of the following:
(a) an aqueous slurry of cellulosic fibers optionally obtained from sources selected from softwood fiber, hardwood fiber, recycled fiber, refined fiber, mill broke fibers, non-wood fibers, including but not limited to straw and wheat pulp, and a mixture of any of the foregoing;
(b) pulp selected from Kraft pulp, bleached pulp, unbleached pulp, process water from pulp, paper, and/or board production, neutral sulfite semi chemical (NSSC) pulp, mechanical pulp, and a mixture of any of the foregoing;
(c) a stock selected from a thick stock, a thick stock diluted with chemical water, synthetic water, white water, and/or process water, and a thin stock, and a mixture of any of the foregoing;
further wherein the amount of said at least one strengthening system, when added to a papermaking system comprising the furnish composition and/or to the furnish composition is sufficient to improve the strength properties of paper or board produced from said furnish composition compared to when said strengthening system is not added to the papermaking system comprising the furnish composition or to the furnish composition.

9. A papermaking process for manufacturing one or more paper products, optionally one or more absorbent paper products, from a fiber stock comprising cellulosic fibers, wherein said process includes the addition of:
(a) at least one cationic glyoxalated polyacrylamide (“GPAM”) comprising a high molecular weight base polymer, wherein said high molecular weight base polymer has a weight average molecular weight selected from at least 50 kDa, at least 80 kDa, at least 100 kDa, at least 250 kDa, or between 100-5000 kDa or 100-1000 kDa; and
(b) at least one anionic polymeric promoter (“APP”);
wherein
(a) and (b) are both added separately, simultaneously, or as a pre-mixed combination during said papermaking process at one or more time points during papermaking selected from any time before, during, and after the paper product is formed; and/or
(a) and (b) are both added separately, simultaneously, or as a pre-mixed combination at one or more locations in the paper making system; and/or
(a) and (b) may be added as separate compositions in either order or are added as a pre-mixed composition comprising (a) and (b), optionally an aqueous composition, further optionally wherein if (a) and (b) are added separately the addition of (a) and (b) is simultaneous or proximate in time, e.g., (a) and (b) are added within one hour, 30 minutes, 10 minutes, 1 minute, or less than 1 minute of each other.

10. The process of claim 9, wherein said at least one cationic GPAM and said at least one anionic polymeric promoter:
(a) are formulated as dry polymers or as aqueous solutions, each solution having a solids percent by weight range selected from the ranges comprising 1-25%, 1-15%, 2-10%, and 4-8%;
(b) are added during said process to obtain a ratio by weight of GPAM:APP (dry:dry) selected from the ranges comprising 1:20 to 20:1; 1:15 to 15:1, 1:10 to 10:1; 10:1 to 1:2, and 5:1 to 3:1;
(c) when combined, have a net charge selected from the ranges comprising −5 to +5 meq/g, 0 to +5 meq/g, and +1 to +3.5;
(d) are added during said process in a manner selected from adding the aqueous cationic GPAM and APP solutions (i) simultaneously; (ii) sequentially in either order; (iii) together as a pre-mixed solution; and (iv) any combination thereof;
(e) are added during said process in a manner selected from adding said aqueous cationic GPAM and APP solutions (i) to said aqueous fiber stock comprising cellulosic fibers at the wet end of a paper machine prior to formation of said paper product; (ii) to a forming cellulosic fiber web during formation of said paper product; (iii) to one or more surfaces of said paper product after formation of said paper product; and (iv) any combination thereof;
(f) when added to said aqueous fiber stock comprising cellulosic fibers, are added to obtain a dosage of said at least one cationic GPAM selected from the ranges comprising 0.5-25, 3-12, 6-10 lb/ton of dry fibers and a dosage of said at least one anionic polysaccharide promoter selected from the ranges comprising 0.5-15, 1-8, and 2-5 lb/ton of dry fibers; and
(g) are added during said process, wherein points of addition include, but are not limited to, before refining the pulp, after refining the pulp, at the fan pump, before the head box, at the head box, by spraying, printing, coating, and impregnating onto the web, to preformed paper, for example by tub sizing, and on the dried paper sheets, for example by spraying, and any combination thereof.

11. The process of claim 9 or 10, wherein said at least one cationic GPAM comprises one or more of the following:
(a) comprises a glyoxal:base polymer weight ratio range selected from 1:99 to 50:50 and 5:95 to 20:80;
(b) is obtained by reaction of glyoxal with said high molecular weight base polymer, wherein said high molecular weight base polymer comprises an acrylamide-based copolymer comprising neutral monomers, cationic monomers, and optionally anionic monomers, further wherein
(i) said neutral monomers are selected from the group of primary amide-containing monomers comprising acrylamide, methacrylamide, ethyl acrylamide, crotonamide, N-methyl acrylamide, N-butyl acrylamide, N-ethyl methacrylamide, and any combination thereof;
(ii) said cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
(iii) said optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
(c) has a percent cationic monomer content ranging from 5-60% by weight, a percent anionic monomer content ranging from 0-50% by weight, and the remainder of the monomer content is nonionic; and/or
(d) has a cationic charge density range selected from the ranges comprising 0.4-5 meq/g, 1-4 meq/g, and 1.4-2 meq/g at pH 8.0.

12. The process of claim 9, 10 or 11, wherein said at least one anionic polymeric promoter comprises one or more of the following:
(a) has a weight average molecular weight selected from at least 10 kDa, at least 50 kDa, at least 100 kDa, at least 250 kDa, and 10-1000 kDa;
(b) comprises a copolymer comprising neutral monomers, anionic monomers, and optionally cationic monomers, wherein
(i) said neutral monomers are selected from the group of vinyl monomers comprising acrylamide-based monomers, including but not limited to, acrylamide, methacrylamide, ethyl acrylamide, crotonamide, N-methyl acrylamide, N-butyl acrylamide, N-ethyl methacrylamide, and any combination thereof; acrylate-based monomers including esters thereof; N-vinylcarbamides; styrene; acrylonitrile; vinyl acetate; N-vinylpyrrolidone; N-vinyl-2-caprolactam; maleic anhydride; vinylethers; and any combinations thereof;
(ii) said cationic monomers are selected from acryloyloxyethyltrimethyl ammonium chloride (“AETAC”), methacryloyloxyethyltrimethylammonium chloride (“MAETAC”), methacrylamidopropyltrimethylammonium chloride (“MAPTAC”), acrylamidopropyltrimethylammonium chloride (“APTAC”), methacryloyloxyethyldimethylammonium sulfate, diallyldimethylammonium chloride (“DADMAC”); dialkylaminoalkyl acrylates and dialkylaminoalkyl methacrylates and their quaternary or acid salts, including but not limited to, dimethylaminoethyl acrylate (“DMAEA”), dimethylaminoethyl methacrylate (“DMAEA”), dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt; dialkylaminoalkylacrylamides and methacrylamides and their quaternary or acid salts, including but not limited to, acryloylamidopropyltrimethylammonium chloride, dimethylaminopropyl acrylamide, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; and diallyldialkylammonium halides, including but not limited to, diallyldiethylammonium chloride and diallyldimethylammonium chloride (“DADMAC”), and any combination thereof; and
(iii) said optional anionic monomers contain functional groups selected from carboxylic acids, sulfonic acids, a phosphonic acids, their corresponding water soluble salts, their corresponding water dispersible salts, and any combination thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid, their corresponding alkali metal, alkaline earth metal, and ammonium salts, and any combination thereof;
(c) has a percent anionic monomer content ranging from 2-60% by weight, a percent cationic monomer content ranging from 0-50% by weight, and the remainder of the monomer content is nonionic; and/or
(d) has an anionic charge density range selected from the ranges comprising −10 to 4 meq/g, −8 to 2 meq/g, and −4 to −1 meq/g at pH 8.0.

13. The process of claim 9, 10, 11 or 12, wherein said fiber stock comprises cellulosic fibers:
(a) comprises an aqueous slurry of cellulosic fibers obtained from sources selected from softwood fiber, hardwood fiber, recycled fiber, refined fiber, mill broke fibers, non-wood fibers, including but not limited to straw and wheat pulp, and a mixture of any of the foregoing;
(b) optionally comprises pulp selected from Kraft pulp, bleached pulp, unbleached pulp, process water from pulp, paper, and/or board production, neutral sulfite semi chemical (NSSC) pulp, mechanical pulp, and a mixture of any of the foregoing;
(c) optionally comprises a stock selected from a thick stock, a thick stock diluted with chemical water, synthetic water, white water, and/or process water, and a thin stock, and a mixture of any of the foregoing; and
(d) has a pH selected from the ranges comprising 4.0-9.0, 5.0-8.0, and 5.5-7.0.

14. The process of any one of claims 9-13, wherein:
(a) said at least one cationic GPAM comprises a high molecular weight base polymer comprising a copolymer of (i) cationic monomers selected from DADMAC, AETAC, and combinations thereof; (ii) nonionic monomers selected from acrylamide, methacrylamide, and combinations thereof; and (iii) optionally anionic monomers selected from acrylic acid, its corresponding water soluble salts thereof, water dispersible alkali metal salts, alkaline earth metal salts, ammonium salts, and combinations thereof; and
(b) said at least one anionic polymeric promoter comprises a copolymer of acrylamide and acrylic acid, its corresponding water soluble salts thereof, water dispersible alkali metal salts, alkaline earth metal salts, ammonium salts, and combinations thereof.

15. The process of any one of claims 9-14, wherein said process results in formation of a paper product, wherein said paper product comprises one or more of the following:
(a) comprises a percent by weight of said at least one cationic GPAM comprising a high molecular weight base polymer selected from the ranges comprising 0.02-10% and 0.05-5% of the dry paper weight;
(b) comprises a percent by weight of said at least one anionic polymeric promoter selected from the ranges comprising 0.02-10% and 0.05-5% of the dry paper weight;
(c) exhibits (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa); and
(d) is selected from the list of paper products comprising a cellulose paperboard web which optionally comprises predominantly cellulose fibers and a fiber-based product including, but not limited to, handsheets, board-based products, beverage carriers, toweling, milk and juice cartons, food trays, paper bags, liner board for corrugated containers, packaging board grade, tissue and towel grade, paper materials, paper towels, diapers, sanitary napkins, training pants, pantiliners, incontinence briefs, tampons, pee pads, litter box liners, coffee filters, air filters, dryer pads, floor cleaning pads, absorbent facial tissue, absorbent bathroom tissue, napkins, wrapping paper, paperboard cartons, bag paper, and other paper products of the like.

16. A paper product comprising one or more compositions or combinations of (a) and (b) for strengthening paper or board according to any one of claims 1-8, obtainable by a process according to any one of claims 9-15, wherein said paper product:
(a) comprises a percent of said at least one cationic GPAM comprising a high molecular weight base polymer selected from the ranges comprising 0.02-10% by weight and 0.05-5% by weight of the dry paper product;
(b) comprises a percent of said at least one anionic polymeric promoter selected from the ranges comprising 0.02-10% by weight and 0.05-5% by weight of the dry paper product;
(c) exhibits (i) an increased dry tensile strength; (ii) an increased initial wet tensile strength; (iii) an increased permanent wet tensile strength; (iv) an increased wet strength as a percent of dry strength; and (v) a decreased wet strength decay over time compared to a paper product prepared in an equivalent manner using a cationic GPAM comprising a low molecular weight base polymer (e.g., less than 50 kDa); and/or
(d) is selected from the list of paper products comprising a cellulose paperboard web which optionally comprises predominantly cellulose fibers and a fiber-based product including, but not limited to, handsheets, board-based products, beverage carriers, toweling, milk and juice cartons, food trays, paper bags, liner board for corrugated containers, packaging board grade, tissue and towel grade, paper materials, paper towels, diapers, sanitary napkins, training pants, pantiliners, incontinence briefs, tampons, pee pads, litter box liners, coffee filters, air filters, dryer pads, floor cleaning pads, absorbent facial tissue, absorbent bathroom tissue, napkins, wrapping paper, paperboard cartons, bag paper, and other paper products of the like.
